(19) United States
(12) Patent Application Publication
(10) Pub. No.: US 2026/0211771 A1
(43) Pub. Date: Jul. 23, 2026

(54) DYNAMIC PARITY GROUP MANAGEMENT FOR MEMORY

(71) Applicant: Micron Technology, Inc., Boise, ID (US)

(72) Inventors: Gianfranco Ferrante, San Giorgio A Cremano (IT); Nicola Colella, Capodrise (CE) (IT)

(21) Appl. No.: 19/450,580

(22) Filed: Jan. 15, 2026

Related U.S. Application Data
(60) Provisional application No. 63/747,855, filed on Jan. 21, 2025.

(51) Int. Cl. G06F 11/10

(52) U.S. Cl. CPC G06F 11/1004

(57) ABSTRACT

Methods, systems, and devices for dynamic parity group management for memory are described. In some instances, a first set of parity bits may be generated for a first group of pagelines and may be stored to a memory system. The memory system may detect a condition (e.g., a data recovery condition) associated with a first page of the first group of pagelines and may move the data to a second page. The memory system may generate a second set of parity bits using the first set of parity bits and a representation of the data stored to the first page. In some examples, the memory system may determine that a third page of the first group of pagelines includes an error (e.g., an uncorrectable error) and may recover the associated data using the second set of parity bits.

### CROSS REFERENCE

The present Application for Patent claims priority to U.S. Patent Application No. 63/747,855 by Ferrante et al., entitled “DYNAMIC PARITY GROUP MANAGEMENT FOR MEMORY,” filed Jan. 21, 2025, which is assigned to the assignee hereof, and which is expressly incorporated by reference in its entirety herein.

### TECHNICAL FIELD

The following relates to one or more systems for memory, including dynamic parity group management.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not- or (NOR) and not- and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states if disconnected from an external power source.

### BRIEF DESCRIPTION OF THE DRAWINGS

FIG. 1 shows an example of a system that supports dynamic parity group management for memory in accordance with examples as disclosed herein.

FIGS. 2A and 2B show examples of block diagrams that support dynamic parity group management for memory in accordance with examples as disclosed herein.

FIG. 3 shows an example of a process that supports dynamic parity group management for memory in accordance with examples as disclosed herein.

FIG. 4 shows a block diagram of a memory system that supports dynamic parity group management for memory in accordance with examples as disclosed herein.

FIGS. 5 and 6 show flowcharts illustrating a method or methods that support dynamic parity group management for memory in accordance with examples as disclosed herein.

### DETAILED DESCRIPTION

A memory system may generate parity information to correct errors associated with one or more pages of memory cells. For example, a memory system may implement an error recovery or error correction scheme (e.g., a redundant array of independent not-AND (NAND) (RAIN) scheme) to protect data against various errors and conditions. The error recovery scheme may generate and store parity information on a per RAIN group basis. For example, the memory system may generate and store parity information for a plurality of (e.g., a group of) pagelines of a virtual block by performing an operation (e.g., a logical operation, an exclusive- or (XOR) operation) on data stored to the respective pagelines. A pageline may refer to a set of physical pages (e.g., a collection of pages) having a same relative address of each physical block that makes up a virtual block. A virtual block may refer to a set of physical blocks from each plane of the memory system. Each physical block may include a relatively large quantity of physical pages corresponding to multiple pagelines.

In some examples, however, such error recovery schemes may be unable to recover data if multiple errors occur. For example, a page (e.g., a first page of a first pageline) may experience an uncorrectable error (UECC), a read disturbance, a cross-temperature effect, or a similar event or condition that results in the first data being recovered using the existing parity bits and moved (e.g., to a second page, a different page). In such instances, because the first data contributed to the generation of the parity bits for the RAIN group, the error recovery scheme may be unable to recover subsequent data errors associated with the RAIN group. For example, if another page (e.g., a third page) of a pageline contributing to the RAIN group experiences a condition that initiates the error recovery scheme, the error recovery scheme may be unable to recover the associated data due to the first data being unreadable. Accordingly, a system capable of recovering data for a RAIN group after an associated set of parity bits has been generated and after data has been moved due to the occurrence of one or more events or conditions may be desirable.

A system capable of recovering data for a RAIN group after an associated set of parity bits has been generated and after data has been moved due to the occurrence of one or more events or conditions is described herein. In some instances, if data associated with a RAIN group is recovered and moved, the memory system may regenerate the parity bits for the RAIN group. For example, a first set of parity bits may be generated for a RAIN group by performing an operation on data stored to each pageline of the RAIN group. If a page experiences a UECC or other type of condition (e.g., a data associated with data retention of the page), the error recovery scheme may recover the data using the generated parity bits and may move the data to another location. In such instances, the memory system may perform a logical operation (e.g., an XOR operation) on the previously generated parity bits and on the recovered data (e.g., a representation of the data) to generate a second set of parity bits.

The second set of parity bits may be associated with the RAIN group without the first data (e.g., the moved data) contributing to the bits' generation. For example, the second set of parity bits may be associated with data stored to the group of pagelines of the virtual block composing the RAIN group under analysis other than the data moved from the first page to the second page. Accordingly, if another page (e.g., a third page) of a pageline contributing to the RAIN group experiences a condition that initiates the error recovery scheme, the error recovery scheme may be able to recover the associated data despite the first data being unreadable, because it no longer contributes to the updated version of the parity bits set for the corresponding RAIN group. Thus, such an error recovery scheme may improve the overall performance and reliability of the memory system by being able to recover data for multiple pages of a RAIN group if UECCs or other types of conditions occur.

In addition to applicability in memory systems as described herein, techniques for dynamic parity group management for memory may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by allowing for data recovery for multiple pages of a RAIN group if UECCs or other types of conditions occur, which may improve the overall performance and reliability of the memory system, among other benefits.

In addition to applicability in memory systems described herein, techniques for dynamic parity group management for memory may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by allowing for data recovery for multiple pages of a RAIN group if UECCs or other types of conditions occur, which may improve the overall performance and reliability of the memory system, among other benefits.

Features of the disclosure are illustrated and described in the context of systems, devices, and circuits. Features of the disclosure are further illustrated and described in the context of block diagrams, processes, and flowcharts.

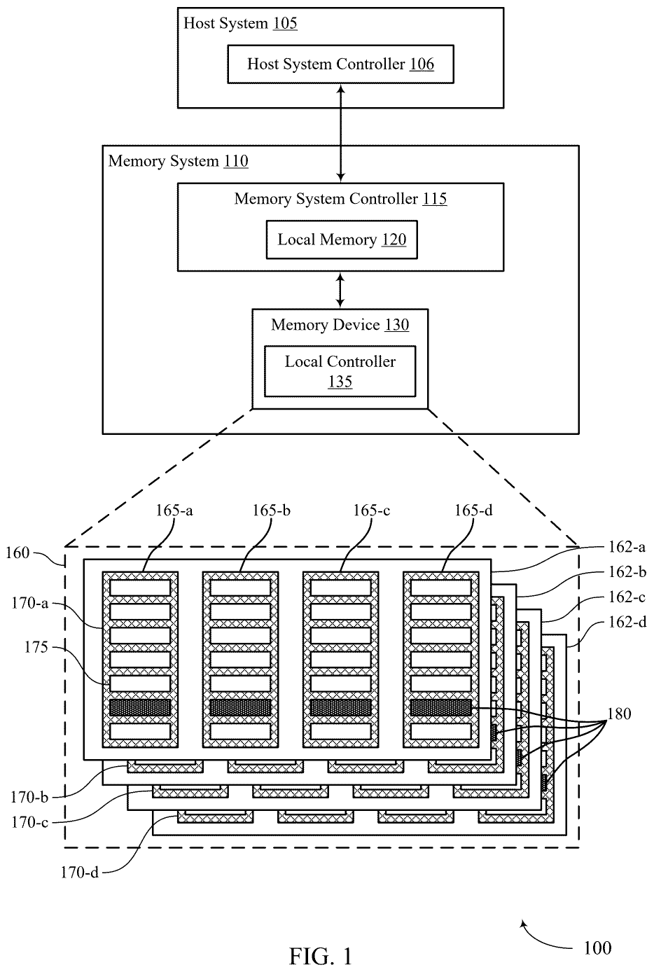

FIG. 1 shows an example of a system 100 that supports dynamic parity group management for memory in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IOT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although one memory device 130 is shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof.

Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130 may include a local controller 135. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a package 160 that includes one or more dies 162. A die 162 may, in some examples, be a piece of electronics-grade semiconductor cut from a wafer (e.g., a silicon die cut from a silicon wafer). Each die 162 may include one or more planes 165, and each plane 165 may include a respective set of blocks 170 (e.g., physical blocks 170), where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively. In some instances, a respective block from each plane (e.g., a block 170 from each plane 165) of one or more memory dies 162 may be collectively referred to as a virtual block 180. In some cases, a virtual block may include blocks 170 from different memory dies 162 or different memory devices 130 (e.g., including blocks in one or more planes of memory device 130). In some cases, the blocks 170 within a virtual block may have the same block address within their respective planes 165 (e.g., block 170-a may be “block 0” of plane 165-a, block 170-b may be “block 0” of plane 165-b, and so on), or in some cases blocks 170 may have different block addresses. In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The memory system 110 may be capable of recovering data for a RAIN group after an associated set of parity bits has been generated and after data has been moved due to the occurrence of one or more events or conditions. In some instances, if data associated with a RAIN group is recovered and moved, the memory system 110 may regenerate the parity bits for the RAIN group. For example, a first set of parity bits may be generated for a RAIN group by performing an operation on data stored to each initially reliable pageline of the RAIN group. If a page 175 experiences a UECC or other type of condition (e.g., a data associated with data retention of the page), the error recovery scheme may recover the data using the generated parity bits and the content of the remaining pages composing the RAIN group and may move the data to another location. In such instances, the memory system may perform a logical operation (e.g., an XOR operation) on the previously generated parity bits and on the recovered data (e.g., a representation of the data) to generate a second set of parity bits.

The second set of parity bits may be associated with the RAIN group without the first data (e.g., the moved data) contributing to the bits' generation. For example, the second set of parity bits may be associated with data stored to the group of pagelines of the virtual block 170 other than the data moved from a first page to a second page. Accordingly, if another page (e.g., a third page) of a pageline contributing to the RAIN group experiences a condition that initiates the error recovery scheme, the error recovery scheme may be able to recover the associated data despite the first data being moved. Thus, such an error recovery scheme may improve the overall performance and reliability of the memory system 110 by being able to recover data for multiple pages of a RAIN group if UECCs or other types of conditions occur.

The system 100 may include any quantity of non-transitory computer readable media that support error reduction techniques for memory systems. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

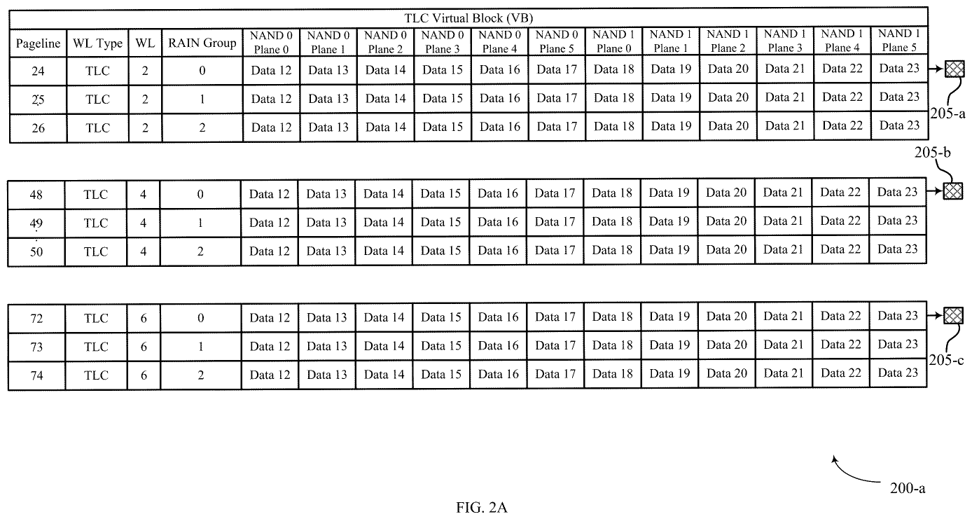

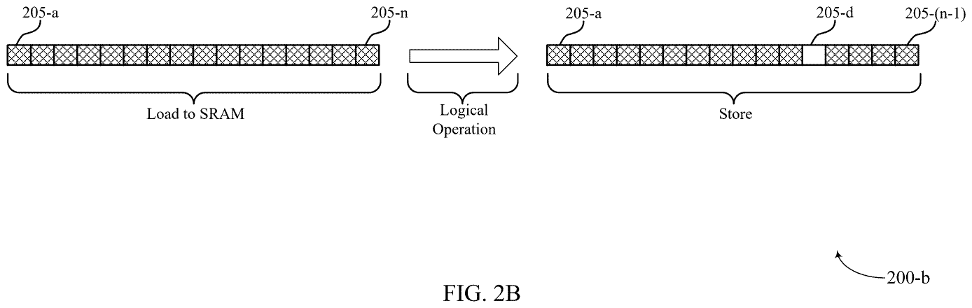

FIG. 2A shows an example of a block diagram 200-a that supports dynamic parity group management for memory in accordance with examples as disclosed herein. The block diagram 200-a may illustrate an example of aspects of a virtual block (e.g., a TLC virtual block). In some examples, the virtual block may be associated with or otherwise include one or more pagelines, word lines (WLs), RAIN groups, memory devices (e.g., memory devices 130 as described with reference to FIG. 1) and planes (e.g., planes 165 as described with reference to FIG. 1). The block diagram 200-a may illustrate aspects of a memory system (e.g., a memory system 110 as described with reference to FIG. 1) configured to recover data for multiple pages of a RAIN group if UECCs or other types of conditions occur.

In some examples, the block diagram 200-a may illustrate aspects of a TLC virtual block. The virtual block may be an example of a virtual block 170 as described with reference to FIG. 1 and may include memory cells configured to store three bits per cell. In other instances, the block diagram 200-a may illustrate a virtual block having memory cells configured to store a different quantity of bits per cell (e.g., the virtual block may include SLCs, MLCs, QLCs, etc.). The virtual block may be associated with one or more pagelines. As used herein, a pageline may refer to a set of physical pages (e.g., pages 175 as described with reference to FIG. 1) that extend across the available planes of the memory system. Additionally, or alternatively, a virtual block may refer to a set of physical blocks from each plane of the memory system. Each physical block may include a relatively large quantity of physical pages corresponding to one or more pagelines.

In some examples, a single pageline may refer to the pages that extend across the planes of a first memory device and a second memory device. For example, pageline 24 may extend across plane 0 through plane 5 of a first memory device (e.g., NAND 0) and across plane 0 through plane 5 of a second memory device (e.g., NAND 1,). A page associated with NAND 0, Plane 0 may store data (e.g., Data 12), a page associated with NAND 0, Plane 1 may store data (e.g., Data 13), and so on.

In some instances, the associated memory system may be configured with an error recovery scheme, such as a RAIN scheme. The RAIN scheme may include generating parity bits for a RAIN group that includes parity bits from a quantity of pagelines. For example, the quantity of pagelines contributing to a RAIN group may be defined by

$$\frac{\# pagelines in VB}{k}$$

where k represents the quantity of RAIN groups for the virtual block. By way of example, k may be 24, thus pagelines 1, 24, 48, 72, . . . m may be associated with RAIN group 0. Similarly, by way of example, pagelines 2, 25, 49, 73, . . . n may be associated with RAIN group 1. In some examples, k may be a configurable value, thus a virtual block may be associated with any quantity of RAIN groups. Additionally, or alternatively, each pageline may be associated with a respective word line and type of word line. For example, pageline 24 may contribute to RAIN group 0 and may be associated with TLCs of word line 2.

The data stored to each memory device and each plane of a pageline may be used to generate parity bits for a respective RAIN group. For example, a logical operation (e.g., an XOR) operation may be performed on each page of the data stored to pageline 24 to generate parity bits 205-a. Similarly, logical operations may be performed on each page of the data stored to pageline 48 and pageline 72 to generate parity bits 205-b and parity bits 205-c, respectively. The parity bits 205 may then be generated from parity bits 205-a, 205-b, and 205-c (e.g., using XOR operations), and stored as the parity bits 205 for the RAIN group. As shown in FIG. 2B and described below, the parity bits 205 for a RAIN group may be stored (e.g., to the memory system) as a parity pattern and can be used to recover data stored to one or more pages of the associated RAIN group.

In some instances, an associated memory system may receive data to be written to one or more pages. A memory system controller (e.g., a memory system controller 115 as described with reference to FIG. 1) may open the virtual block shown in FIG. 2A and may write data to a plurality of pages. The memory system controller may generate a respective set of parity bits 205 after writing data to a pageline, or may generate each of the parity bits 205 after writing data to each of the pagelines. Collectively, the parity bits 205 may be referred to as a first set of parity bits.

After generating the first set of parity bits, a page of a group of pagelines (e.g., a page of a RAIN group) may experience a condition associated with data retention for the page. For example, a page storing Data 12 of NAND 0, Plane 0 may be associated with a UECC, a read disturbance, a cross-temperature effect, or another type of condition. A cross-temperature effect may occur if data is written to and read from a page at different temperatures. Any of the conditions associated with data retention for the page may result in the associated data being unable to be read (e.g., the data includes an error that is uncorrectable using the ECC associated with the page) or unreliably read (e.g., the data is likely to include an error). Accordingly, in such situations, the memory system (e.g., the memory system controller) may utilize an error recovery scheme (e.g., a RAIN scheme) to recover and move the associated data. For example, the memory system controller may use the first set of parity bits (and the other pages of the RAIN group) to recover (e.g., regenerate) Data 12 of NAND 0, Plane 0. After recovering the data, the memory system controller may move the data to another block, plane, page, or portion of the memory system due to the prior page being defective or otherwise associated with a data retention condition.

In some instances, after moving the data, a different page of the group of pagelines may experience a condition associated with data retention for the page. For example, a page storing Data 20 of NAND 1, Plane 2 may be associated with a UECC, a read disturbance, a cross-temperature effect, or another type of condition. In conventional systems, Data 20 may have been unrecoverable due to Data 12 of NAND 0, Plane 0 contributing to the RAIN group but being unreadable. As such, a conventional system may have been unable to perform a logical operation on the first set of parity bits and the associated data to recover Data 20 because Data 12 also includes an uncorrectable error and the corrected representation of Data 12 was moved from the RAIN group.

However, in the present disclosure, the memory system controller may generate an updated set of parity bits (e.g., a second set of parity bits) after Data 12 was moved from the RAIN group. For example, after moving Data 12, the memory system controller may perform a logical operation (e.g., an XOR operation) on the first set of parity bits and a representation of Data 12 (e.g., the recovered or otherwise regenerated Data 12). By performing the logical operation, the memory system controller may effectively generate a different set of parity bits (e.g., a second set of parity bits) that does not depend on Data 12. Accordingly, if a different page of the group of pagelines (e.g., a third page) experiences a condition associated with data retention for the page, the memory system controller may recover the data using the second set of parity bits and the data stored to the pagelines of the group of pagelines (other than the excluded page). Such an error recovery scheme may improve the overall performance and reliability of the memory system by being able to recover data for multiple pages of a RAIN group if UECCs or other types of conditions occur.

FIG. 2B shows an example of a block diagram 200-b that supports dynamic parity group management for memory in accordance with examples as disclosed herein. The block diagram 200-b may illustrate a possible representation of a data structure used for tracing pagelines whose page contents contributed (e.g., through XOR operations) to the calculation of the most-recent version of a set of parity bits (e.g., a second set of parity bits) associated with a given RAIN group. As described herein, the second set of parity bits may be stored to non-volatile memory of the memory system and may support the recovery of data for multiple pages of a RAIN group if UECCs or other types of conditions occur.

As described herein, a memory system controller (e.g., a memory system controller 115 as described with reference to FIG. 1) may generate one or more parity bits 205 for each pageline of a group of pagelines of a RAIN group. As shown in FIG. 2B, a first set of parity bits may include parity bits 205-a through 205-n, where n represents a total quantity of pagelines of a RAIN group. If the memory system controller identifies or otherwise determines a condition associated with data retention of a page of a group of pagelines, it may load the first set of parity bits to a volatile memory (e.g., SRAM) of the memory system and regenerate or otherwise recover the data using the first set of parity bits. After recovering the data, the memory system controller may move (or copy) the data to another portion of the memory system.

After the data is moved (or otherwise copied) to another portion of the memory system, the memory system controller may perform a logical operation (e.g., an XOR operation) to generate a second set of parity bits. The memory system controller may perform the logical operation on the first set of parity bits and the remaining data stored to the pages of the group of pagelines (e.g., the data other than the data moved to the other portion of the memory system). The logical operation may generate the second set of parity bits, which may include parity bits 205-a through 205-(n−1), where n−1 represents a total quantity of contributing pagelines of a RAIN group. For example, n−1 may represent parity bits associated with the remaining data stored to the pages of the group of pagelines and may not include a parity bit (or parity bits) 205-d. That is, the parity bit (or parity bits) 205-d may not represent an actual parity bit (or parity bits), but may represent the parity bit (or parity bits) that would have been generated but for the data from the associated pageline being moved. In some instances, the second set of parity bits may be stored to a LBA (or a range of LBAs) that is out of range to a host system. As used herein, an LBA (or LBAs) that are out of range to a host system may be otherwise inaccessible to a host system (e.g., a host system 105 as described with reference to FIG. 1).

Accordingly, if the memory system controller determines or otherwise identifies a condition associated with data retention for a page (e.g., a different page than already moved, a third page), the memory system controller may recover the data using the second set of parity bits and the data stored to the pagelines of the group of pagelines. Such an error recovery scheme may improve the overall performance and reliability of the memory system by being able to recover data for multiple pages of a RAIN group if UECCs or other types of conditions occur.

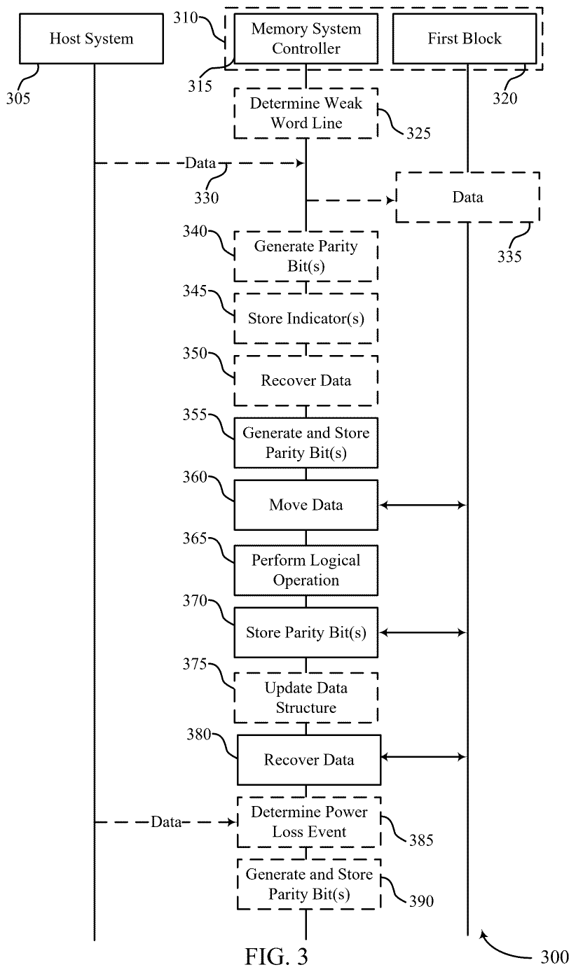

FIG. 3 shows an example of a process 300 that supports dynamic parity group management for memory in accordance with examples as disclosed herein. Aspects of the process 300 may be implemented by one or more controllers, among other components. Additionally, or alternatively, aspects of the process 300 may be implemented as instructions stored in one or more memories (e.g., firmware stored in one or more memories coupled with a memory system 110). For example, the instructions, when executed by one or more controllers (e.g., the memory system controller 115), may cause the one or more controllers (or a device or a system) to perform the operations of the process 300. Alternative examples of the following may be implemented. For example, some steps may be performed in a different order than described or may not be performed at all. In some implementations, steps may include additional features not mentioned below, or further steps may be added.

In some examples, the process 300 may be performed by a host system 305, which may be an example of a host system 105 as described with reference to FIG. 1, and a memory system 310, which may be an example of a memory system 110 as described with reference to FIG. 1. In some examples, the memory system 310 may include a memory system controller 315, which may be an example of a memory system controller 115 as described with reference to FIG. 1, and a first block 320. The first block 320 may be an example of the TLC virtual block described with reference to FIG. 2A. In other examples (not shown), the memory system may include any quantity of blocks in addition to the first block 320.

At 325, a weak word line may be determined. In some instances, the memory system controller 315 may determine the presence or existence of a weak word line. As used herein, a weak word line may refer to a word line that is susceptible to charge loss or otherwise includes memory cells that are susceptible to data errors or data loss. In some instances, weak word lines may be determined during a programming phase of the memory system 310, whereas in other examples weak word lines may be determined during one or more testing operations. Accordingly, the memory system controller 315 may determine the presence of a weak word line based on information stored to the memory system 310 (e.g., during programming) or on-the-fly (e.g., during a testing operation or during normal operation). In some instances, the weak word line may be associated with a pageline that is a part of a RAIN group as described herein.

At 330, data may be received. In some instances, the host system 305 may transmit data to the memory system 310 for writing to the first block 320. The data may be received by the memory system controller 315.

At 335, the data may be written to the first block 320. In some instances, the memory system controller 315 may write the data to the first block 320 in response to receiving the data (e.g., at 330). In some examples, the memory system controller 315 may suppress writing any portions of the data to word lines determined to be weak word lines. For example, the memory system controller 315 may have determined (e.g., at 325) that a first page of a first pageline of a first group of pagelines (e.g., a RAIN group) is associated with a weak word line and may suppress writing data to the first page. In some instances, the memory system controller 315 may discard the data not written to the first block 320.

At 340, one or more parity bits may be generated. In some instances, the memory system controller 315 may generate one more parity bits for the pagelines associated with the received and written data. The memory system controller 315 may generate the one or more parity bits without using the first page. That is, the memory system controller 315 may perform a logical operation on the data written to the first block 320, which may not include data written to the first page. Accordingly, the first page may not contribute to the generation of the parity bits at 340.

At 345, one or more indicators may be stored to the memory system. In some instances, the memory system controller may store one or more indicators to volatile memory (e.g., SRAM) or to non-volatile memory of the memory system 310. The one or more indicators may indicate (e.g., to the memory system controller 315 or to another component of the memory system 310) that the first page did not contribute to the generation of the parity bits (e.g., at 340). Accordingly, the indication may be used in subsequent data recovery operations. In some instances, the one or more indicators may be stored to a LBA (or a range of LBAs) that is out of range to a host system.

In some instances, an indicator may be the bits of the bitmap data structure. For saving RAM and storage space, the bitmap could include a bit for each pageline of the RAIN group that contributed to calculating the parity bits associated with the RAIN group the pageline is associated with. All content that contributed to the parity bits of a RAIN group, except for the bit(s) under retrieval, can be read and XOR-ed with parity bits for retrieving the page content that cannot be read from the memory system.

At 350, data may be recovered. In some instances, the memory system controller 315 may recover data from the first block 320. For example, the memory system controller 315 may determine that a page (e.g., a second page, a page other than the first page) includes a UECC or other type of condition. The memory system controller 315 may, using the stored indication, recover or otherwise regenerate the data using the first set of parity bits and pages of the first group of pagelines other than the first page. Accordingly, the memory system 310 described herein may be configured to perform error correction schemes relatively effectively and efficiently by refraining from using weak word lines in parity generation and data recovery.

At 355, one or more parity bits may be generated and stored. In some instances, the memory system controller 315 may generate one more parity bits by performing a logical operation (e.g., XOR-ing) the page content of a pageline of a first group of pagelines. For example, the memory system controller 315 may generate one or more parity bits for each pageline of a RAIN group of the first block 320. The memory system controller 315 may store the parity bits to volatile memory (e.g., SRAM) or to non-volatile memory of the memory system 310.

At 360, data stored to the first group of pagelines may be moved. In some instances, the memory system controller 315 may move the data in response to determining a UECC or other data retention characteristic associated with the data. For example, the memory system controller 315 may determine a UECC, a read disturb, a cross-temperature effect, or a similar characteristic and may move the data from a first page of a first pageline to a second page. The second page may be included in a different pageline, a different block, or a different memory device of the memory system 310.

At 365, a logical operation may be performed. In some instances, the memory system controller 315 may perform a logical operation on the first set of parity bits and on a representation of the data moved to the second page. In some examples, the first set of parity bits may be loaded from non-volatile memory to volatile memory (e.g., SRAM) prior to the logical operation being performed. By performing a logical operation, such as an XOR operation, on the first set of parity bits and the representation of the data, a second set of parity bits may be generated. In such an example, the moved data may no longer contribute to the second set of parity bits, which may allow for the second set of parity bits to be used in subsequent data recovery operations.

At 370, the second set of parity bits may be stored. In some instances, the memory system controller 315 may store the second set of parity bits to volatile memory (e.g., SRAM) or to a non-volatile memory of the memory system 310.

At 375, a data structure may be updated. In some instances, the memory system controller may store one or more indicators to volatile memory (e.g., SRAM) or to non-volatile memory of the memory system 310. The one or more indicators may indicate (e.g., to the memory system controller 315 or to another component of the memory system 310) that the data was moved to the second page and that the first page no longer contributes to the second set of parity bits. Accordingly, the indication (e.g., the data structure) may be used in subsequent data recovery operations. In some instances, the data structure may be stored to a LBA (or a range of LBAs) that is out of range to a host system.

At 380, data may be recovered. In some instances, the memory system controller 315 may recover data from the first block 320. For example, the memory system controller 315 may determine that a page (e.g., a third page, a page other than the first page) includes a UECC or other type of condition. The memory system controller 315 may, using the stored indication (e.g., the data structure), recover or otherwise regenerate the data using the second set of parity bits and pages of the first group of pagelines other than the first page.

At 385, a power loss event may be detected. In some instances, the memory system controller 315 may detect the power loss event when receiving and/or writing data to the first block 320. The power loss event may be a synchronous power loss event or an asynchronous power loss event.

At 390, one or more parity bits may be generated. In some instances, the memory system controller 315 may generate one more parity bits for the group of pagelines having been written when the power loss event occurred. For example, the memory system controller 315 may generate the parity bits for the pagelines of the group other than the pageline being written to when the power loss event occurred. The memory system controller 315 may store one or more indicators to volatile memory (e.g., SRAM) or to non-volatile memory of the memory system 310. The one or more indicators may indicate (e.g., to the memory system controller 315 or to another component of the memory system 310) which pages of the pageline did not contribute to the generation of the parity bits. The indication may be used in subsequent data recovery operations. Accordingly, such error recovery schemes described herein may improve the overall performance and reliability of the memory system 310 by being able to recover data for multiple pages of a RAIN group if UECCs or other types of conditions occur.

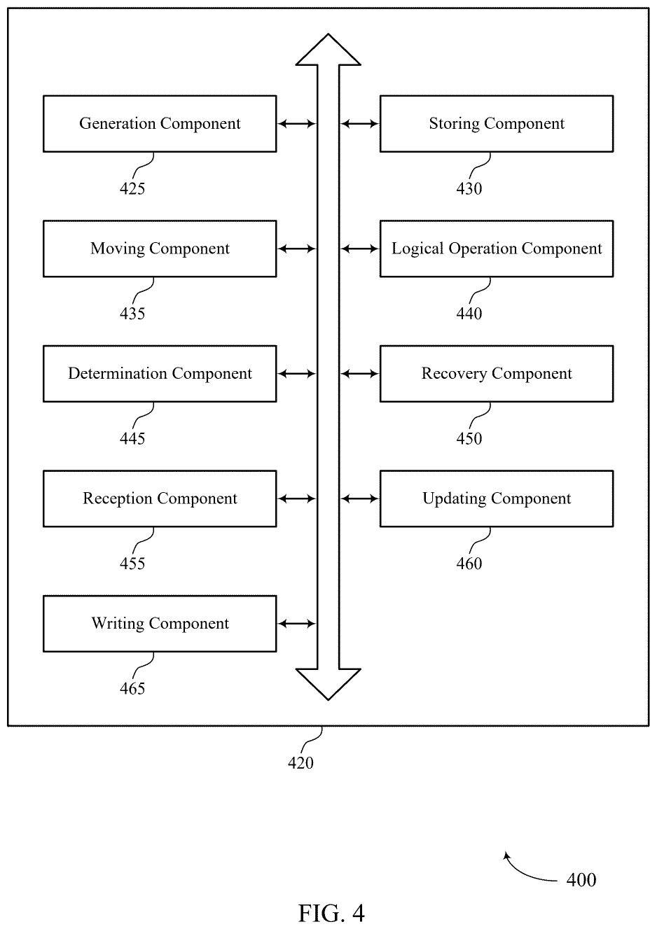

FIG. 4 shows a block diagram 400 of a memory system 420 that supports dynamic parity group management for memory in accordance with examples as disclosed herein. The memory system 420 may be an example of aspects of a memory system as described with reference to FIGS. 1 through 3. The memory system 420, or various components thereof, may be an example of means for performing various aspects of dynamic parity group management for memory as described herein. For example, the memory system 420 may include a generation component 425, a storing component 430, a moving component 435, a logical operation component 440, a determination component 445, a recovery component 450, a reception component 455, an updating component 460, a writing component 465, or any combination thereof. Each of these components, or components of subcomponents thereof (e.g., one or more processors, one or more memories), may communicate, directly or indirectly, with one another (e.g., via one or more buses).

The generation component 425 may be configured as or otherwise support a means for generating a first set of parity bits for a first group of pagelines of the memory system, where the first set of parity bits is associated with each pageline of the first group of pagelines. The storing component 430 may be configured as or otherwise support a means for storing the first set of parity bits to the memory system. The moving component 435 may be configured as or otherwise support a means for moving data stored to a first page of a first pageline of the first group of pagelines to a second page in response to determining a condition associated with data retention of the first page. The logical operation component 440 may be configured as or otherwise support a means for performing, in accordance with moving the data from the first page to the second page, a logical operation on the first set of parity bits and on a representation of the data stored to the first page to generate a second set of parity bits for the first group of pagelines. In some examples, the storing component 430 may be configured as or otherwise support a means for storing the second set of parity bits to the memory system. The determination component 445 may be configured as or otherwise support a means for determining that a third page of the first group of pagelines includes an uncorrectable error. The recovery component 450 may be configured as or otherwise support a means for recovering second data corresponding to the third page using other pages of the first group of pagelines and the second set of parity bits.

In some examples, the updating component 460 may be configured as or otherwise support a means for updating a data structure of the memory system to indicate that the data was moved from the first page to the second page in response to moving the data from the first page to the second page.

In some examples, to support determining the condition associated with the data retention of the first page, the determination component 445 may be configured as or otherwise support a means for determining an occurrence of an uncorrectable error, a read disturbance, a cross-temperature effect, or a combination thereof associated with the data stored to the first page.

In some examples, to support determining the condition associated with the data retention of the first page, the determination component 445 may be configured as or otherwise support a means for determining that a logical block address associated with the first page is invalid.

In some examples, to support storing the first set of parity bits, the storing component 430 may be configured as or otherwise support a means for storing the first set of parity bits to a non-volatile memory in response to closing a virtual block of the non-volatile memory.

In some examples, the storing component 430 may be configured as or otherwise support a means for storing the second set of parity bits to a logical block address of the memory system that is out of range to a host system.

In some examples, the determination component 445 may be configured as or otherwise support a means for determining that a third page of the first group of pagelines is associated with a weak word line. In some examples, the updating component 460 may be configured as or otherwise support a means for updating a data structure of the memory system to indicate that the third page is not used to contribute to the first set of parity bits in response to determining that the third page is associated with a weak word line.

In some examples, the writing component 465 may be configured as or otherwise support a means for writing a generated data pattern to the third page in response to determining that the third page is associated with a weak word line.

In some examples, the determination component 445 may be configured as or otherwise support a means for determining an occurrence of a power loss event when writing data to a fourth page. In some examples, the generation component 425 may be configured as or otherwise support a means for generating a third set of parity bits for a second group of pagelines of the memory system, where the third set of parity bits is associated with pagelines that do not include the fourth page.

In some examples, the determination component 445 may be configured as or otherwise support a means for determining an occurrence of a power loss event when writing second data to a fourth page of a third pageline of a third group of pagelines. In some examples, the generation component 425 may be configured as or otherwise support a means for generating a fourth set of parity bits based at least in part on one or more pages of the third group of pagelines, the one or more pages being exclusive of the fourth page. In some examples, the storing component 430 may be configured as or otherwise support a means for storing an indication that the fourth page is not used to contribute to the fourth set of parity bits to the memory system.

In some examples, the logical operation includes an exclusive- or (XOR) operation.

In some examples, the first group of pagelines includes a plurality of pages of one or more planes of one or more memory devices having a same page address.

In some examples, the recovery component 450 may be configured as or otherwise support a means for recovering the representation of the data stored to the first page using other pages of the first group of pagelines and the first set of parity bits.

In some examples, to support generating the first set of parity bits, the logical operation component 440 may be configured as or otherwise support a means for performing a second logical operation on data stored to each pageline of the first group of pagelines.

In some examples, the determination component 445 may be configured as or otherwise support a means for determining that a first page of a first pageline of a first group of pagelines of the memory system is associated with a weak word line. The reception component 455 may be configured as or otherwise support a means for receiving data for storing in the memory system. In some examples, the storing component 430 may be configured as or otherwise support a means for storing the data to a block of the memory system including the first page based at least in part on receiving the data, where storing the data includes suppressing a write operation to the first page based at least in part on the first page being associated with the weak word line. In some examples, the generation component 425 may be configured as or otherwise support a means for generating a first set of parity bits for the first group of pagelines of the memory system based at least in part on storing the data to the block. In some examples, the storing component 430 may be configured as or otherwise support a means for storing, to the memory system, an indicator that the first page does not contribute to the first set of parity bits based at least in part on generating the first set of parity bits.

In some examples, the storing component 430 may be configured as or otherwise support a means for storing an indication that the first page of the first pageline is associated with a weak word line, where generating the first set of parity bits for the first group of pagelines is based at least in part on storing the indication that the first page of the first pageline is associated with a weak word line.

In some examples, the determination component 445 may be configured as or otherwise support a means for determining that a second page of the first group of pagelines includes an uncorrectable error. In some examples, the recovery component 450 may be configured as or otherwise support a means for recovering second data corresponding to the second page using other pages of the first group of pagelines and the first set of parity bits.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

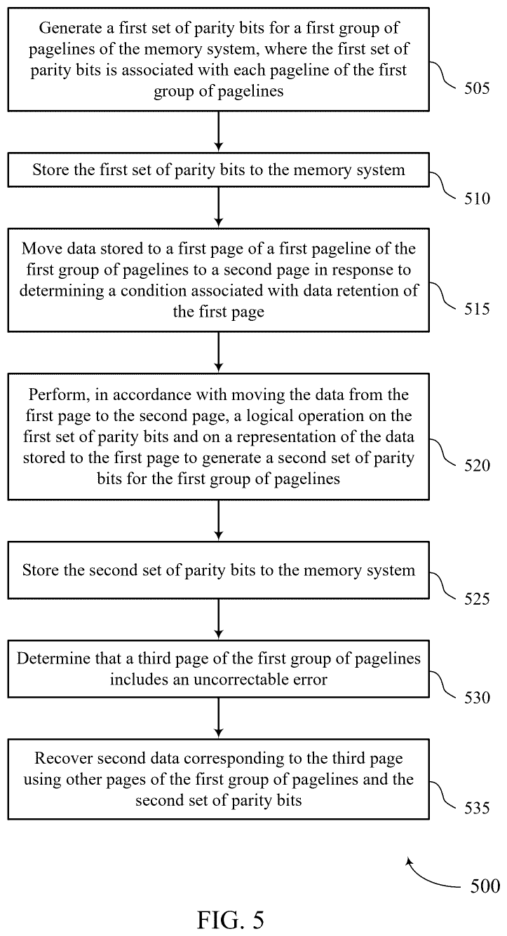

FIG. 5 shows a flowchart illustrating a method 500 that supports dynamic parity group management for memory in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include generating a first set of parity bits for a first group of pagelines of the memory system, where the first set of parity bits is associated with each pageline of the first group of pagelines. In some examples, aspects of the operations of 505 may be performed by a generation component 425 as described with reference to FIG. 4.

At 510, the method may include storing the first set of parity bits to the memory system. In some examples, aspects of the operations of 510 may be performed by a storing component 430 as described with reference to FIG. 4.

At 515, the method may include moving data stored to a first page of a first pageline of the first group of pagelines to a second page in response to determining a condition associated with data retention of the first page. In some examples, aspects of the operations of 515 may be performed by a moving component 435 as described with reference to FIG. 4.

At 520, the method may include performing, in accordance with moving the data from the first page to the second page, a logical operation on the first set of parity bits and on a representation of the data stored to the first page to generate a second set of parity bits for the first group of pagelines. In some examples, aspects of the operations of 520 may be performed by a logical operation component 440 as described with reference to FIG. 4.

At 525, the method may include storing the second set of parity bits to the memory system. In some examples, aspects of the operations of 525 may be performed by a storing component 430 as described with reference to FIG. 4.

At 530, the method may include determining that a third page of the first group of pagelines includes an uncorrectable error. In some examples, aspects of the operations of 530 may be performed by a determination component 445 as described with reference to FIG. 4.

At 535, the method may include recovering second data corresponding to the third page using other pages of the first group of pagelines and the second set of parity bits. In some examples, aspects of the operations of 535 may be performed by a recovery component 450 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for generating a first set of parity bits for a first group of pagelines of the memory system, where the first set of parity bits is associated with each pageline of the first group of pagelines; storing the first set of parity bits to the memory system; moving data stored to a first page of a first pageline of the first group of pagelines to a second page in response to determining a condition associated with data retention of the first page; performing, in accordance with moving the data from the first page to the second page, a logical operation on the first set of parity bits and on a representation of the data stored to the first page to generate a second set of parity bits for the first group of pagelines; storing the second set of parity bits to the memory system; determining that a third page of the first group of pagelines includes an uncorrectable error; and recovering second data corresponding to the third page using other pages of the first group of pagelines and the second set of parity bits.

Aspect 2: The method, apparatus, or non-transitory computer-readable medium of aspect 1, further including operations, features, circuitry, logic, means, or instructions, or any combination thereof for updating a data structure of the memory system to indicate that the data was moved from the first page to the second page in response to moving the data from the first page to the second page.

Aspect 3: The method, apparatus, or non-transitory computer-readable medium of any of aspects 1 through 2, where determining the condition associated with the data retention of the first page includes operations, features, circuitry, logic, means, or instructions, or any combination thereof for determining an occurrence of an uncorrectable error, a read disturbance, a cross-temperature effect, or a combination thereof associated with the data stored to the first page.

Aspect 4: The method, apparatus, or non-transitory computer-readable medium of any of aspects 1 through 3, where determining the condition associated with the data retention of the first page includes operations, features, circuitry, logic, means, or instructions, or any combination thereof for determining that a logical block address associated with the first page is invalid.

Aspect 5: The method, apparatus, or non-transitory computer-readable medium of any of aspects 1 through Error! Reference source not found., further including operations, features, circuitry, logic, means, or instructions, or any combination thereof for storing the second set of parity bits to a logical block address of the memory system that is out of range to a host system.

Aspect 6: The method, apparatus, or non-transitory computer-readable medium of any of aspects 1 through 5, further including operations, features, circuitry, logic, means, or instructions, or any combination thereof for determining that a third page of the first group of pagelines is associated with a weak word line and updating a data structure of the memory system to indicate that the third page is not used to contribute to the first set of parity bits in response to determining that the third page is associated with a weak word line.

Aspect 7: The method, apparatus, or non-transitory computer-readable medium of aspect 6, further including operations, features, circuitry, logic, means, or instructions, or any combination thereof for writing a generated data pattern to the third page in response to determining that the third page is associated with a weak word line.

Aspect 8: The method, apparatus, or non-transitory computer-readable medium of any of aspects 1 through 7, further including operations, features, circuitry, logic, means, or instructions, or any combination thereof for determining an occurrence of a power loss event when writing data to a fourth page and generating a third set of parity bits for a second group of pagelines of the memory system, where the third set of parity bits is associated with pagelines that do not include the fourth page.

Aspect 9: The method, apparatus, or non-transitory computer-readable medium of any of aspects 1 through 8, further including operations, features, circuitry, logic, means, or instructions, or any combination thereof for determining an occurrence of a power loss event when writing second data to a fourth page of a third pageline of a third group of pagelines; generating a fourth set of parity bits based at least in part on one or more pages of the third group of pagelines, the one or more pages being exclusive of the fourth page; and storing an indication that the fourth page is not used to contribute to the fourth set of parity bits to the memory system.

Aspect 10: The method, apparatus, or non-transitory computer-readable medium of any of aspects 1 through 9, where the logical operation includes an exclusive- or (XOR) operation.

Aspect 11: The method, apparatus, or non-transitory computer-readable medium of any of aspects 1 through 10, where the first group of pagelines includes a plurality of pages of one or more planes of one or more memory devices having a same page address.

Aspect 12: The method, apparatus, or non-transitory computer-readable medium of any of aspects 1 through 11, further including operations, features, circuitry, logic, means, or instructions, or any combination thereof for recovering the representation of the data stored to the first page using other pages of the first group of pagelines and the first set of parity bits.

Aspect 13: The method, apparatus, or non-transitory computer-readable medium of any of aspects 1 through 12, where generating the first set of parity bits includes operations, features, circuitry, logic, means, or instructions, or any combination thereof for performing a second logical operation on data stored to each pageline of the first group of pagelines.

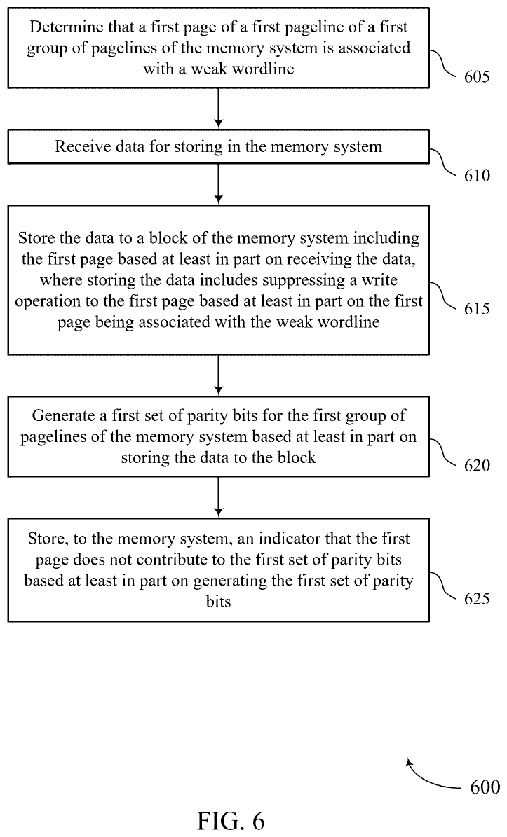

FIG. 6 shows a flowchart illustrating a method 600 that supports dynamic parity group management for memory in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include determining that a first page of a first pageline of a first group of pagelines of the memory system is associated with a weak word line. In some examples, aspects of the operations of 605 may be performed by a determination component 445 as described with reference to FIG. 4.

At 610, the method may include receiving data for storing in the memory system. In some examples, aspects of the operations of 610 may be performed by a reception component 455 as described with reference to FIG. 4.

At 615, the method may include storing the data to a block of the memory system including the first page based at least in part on receiving the data, where storing the data includes suppressing a write operation to the first page based at least in part on the first page being associated with the weak word line. In some examples, aspects of the operations of 615 may be performed by a storing component 430 as described with reference to FIG. 4.

At 620, the method may include generating a first set of parity bits for the first group of pagelines of the memory system based at least in part on storing the data to the block. In some examples, aspects of the operations of 620 may be performed by a generation component 425 as described with reference to FIG. 4.

At 625, the method may include storing, to the memory system, an indicator that the first page does not contribute to the first set of parity bits based at least in part on generating the first set of parity bits. In some examples, aspects of the operations of 625 may be performed by a storing component 430 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 14: A method, apparatus, or non-transitory computer-readable medium including operations, features, circuitry, logic, means, or instructions, or any combination thereof for determining that a first page of a first pageline of a first group of pagelines of the memory system is associated with a weak word line; receiving data for storing in the memory system; storing the data to a block of the memory system including the first page based at least in part on receiving the data, where storing the data includes suppressing a write operation to the first page based at least in part on the first page being associated with the weak word line; generating a first set of parity bits for the first group of pagelines of the memory system based at least in part on storing the data to the block; and storing, to the memory system, an indicator that the first page does not contribute to the first set of parity bits based at least in part on generating the first set of parity bits.

Aspect 15: The method, apparatus, or non-transitory computer-readable medium of aspect 14, further including operations, features, circuitry, logic, means, or instructions, or any combination thereof for storing an indication that the first page of the first pageline is associated with a weak word line, where generating the first set of parity bits for the first group of pagelines is based at least in part on storing the indication that the first page of the first pageline is associated with a weak word line.

Aspect 16: The method, apparatus, or non-transitory computer-readable medium of any of aspects 14 through 15, further including operations, features, circuitry, logic, means, or instructions, or any combination thereof for determining that a second page of the first group of pagelines includes an uncorrectable error and recovering second data corresponding to the second page using other pages of the first group of pagelines and the first set of parity bits.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The term “layer” or “level” used herein refers to a stratum or sheet of a geometrical structure (e.g., relative to a substrate). Each layer or level may have three dimensions (e.g., height, width, and depth) and may cover at least a portion of a surface. For example, a layer or level may be a three dimensional structure where two dimensions are greater than a third, e.g., a thin-film. Layers or levels may include different elements, components, and/or materials. In some examples, one layer or level may be composed of two or more sublayers or sublevels.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
generate a first set of parity bits for a first group of pagelines of the memory system, wherein the first set of parity bits is associated with each pageline of the first group of pagelines;
store the first set of parity bits to the memory system;
move data stored to a first page of a first pageline of the first group of pagelines to a second page in response to determining a condition associated with data retention of the first page;
perform, in accordance with moving the data from the first page to the second page, a logical operation on the first set of parity bits and on a representation of the data stored to the first page to generate a second set of parity bits for the first group of pagelines;
store the second set of parity bits to the memory system;
determine that a third page of the first group of pagelines comprises an uncorrectable error; and
recover second data corresponding to the third page using other pages of the first group of pagelines and the second set of parity bits.

2. The memory system of claim 1, wherein the processing circuitry is further configured to cause the memory system to:
update a data structure of the memory system to indicate that the data was moved from the first page to the second page in response to moving the data from the first page to the second page.

3. The memory system of claim 1, wherein determining the condition associated with the data retention of the first page comprises the processing circuitry configured to cause the memory system to:
determine an occurrence of an uncorrectable error, a read disturbance, a cross-temperature effect, or a combination thereof associated with the data stored to the first page.

4. The memory system of claim 1, wherein determining the condition associated with the data retention of the first page comprises the processing circuitry configured to cause the memory system to:
determine that a logical block address associated with the first page is invalid.

5. The memory system of claim 1, wherein the processing circuitry is further configured to cause the memory system to:
store the second set of parity bits to a logical block address of the memory system that is out of range to a host system.

6. The memory system of claim 1, wherein the processing circuitry is further configured to cause the memory system to:
determine that a third page of the first group of pagelines is associated with a weak word line; and
update a data structure of the memory system to indicate that the third page is not used to contribute to the first set of parity bits in response to determining that the third page is associated with a weak word line.

7. The memory system of claim 6, wherein the processing circuitry is further configured to cause the memory system to:
write a generated data pattern to the third page in response to determining that the third page is associated with a weak word line.

8. The memory system of claim 1, wherein the processing circuitry is further configured to cause the memory system to:
determine an occurrence of a power loss event when writing data to a fourth page; and
generate a third set of parity bits for a second group of pagelines of the memory system, wherein the third set of parity bits is associated with pagelines that do not include the fourth page.

9. The memory system of claim 1, wherein the processing circuitry is further configured to cause the memory system to:
determine an occurrence of a power loss event when writing second data to a fourth page of a third pageline of a third group of pagelines;
generate a fourth set of parity bits based at least in part on one or more pages of the third group of pagelines, the one or more pages being exclusive of the fourth page; and
store an indication that the fourth page is not used to contribute to the fourth set of parity bits to the memory system.

10. The memory system of claim 1, wherein the logical operation comprises an exclusive- or (XOR) operation.

11. The memory system of claim 1, wherein the first group of pagelines comprises a plurality of pages of one or more planes of one or more memory devices having a same page address.

12. The memory system of claim 1, wherein the processing circuitry is further configured to cause the memory system to:
recover the representation of the data stored to the first page using other pages of the first group of pagelines and the first set of parity bits.

13. The memory system of claim 1, wherein generating the first set of parity bits comprises the processing circuitry configured to cause the memory system to:
perform a second logical operation on data stored to each pageline of the first group of pagelines.

14. A memory system, comprising:
one or more memory devices; and
processing circuitry coupled with the one or more memory devices and configured to cause the memory system to:
determine that a first page of a first pageline of a first group of pagelines of the memory system is associated with a weak wordline;
receive data for storing in the memory system;
store the data to a block of the memory system comprising the first page based at least in part on receiving the data, wherein storing the data comprises suppressing a write operation to the first page based at least in part on the first page being associated with the weak wordline;
generate a first set of parity bits for the first group of pagelines of the memory system based at least in part on storing the data to the block; and
store, to the memory system, an indicator that the first page does not contribute to the first set of parity bits based at least in part on generating the first set of parity bits.

15. The memory system of claim 14, wherein the processing circuitry is further configured to cause the memory system to:
store an indication that the first page of the first pageline is associated with a weak wordline, wherein generating the first set of parity bits for the first group of pagelines is based at least in part on storing the indication that the first page of the first pageline is associated with a weak wordline.

16. The memory system of claim 14, wherein the processing circuitry is further configured to cause the memory system to:
determine that a second page of the first group of pagelines comprises an uncorrectable error; and
recover second data corresponding to the second page using other pages of the first group of pagelines and the first set of parity bits.

17. A non-transitory computer-readable medium storing code, the code comprising instructions executable by one or more processors to:
generate a first set of parity bits for a first group of pagelines of a memory system, wherein the first set of parity bits is associated with each pageline of the first group of pagelines;
store the first set of parity bits to the memory system;
move data stored to a first page of a first pageline of the first group of pagelines to a second page in response to determining a condition associated with data retention of the first page;
perform, in accordance with moving the data from the first page to the second page, a logical operation on the first set of parity bits and on a representation of the data stored to the first page to generate a second set of parity bits for the first group of pagelines;
store the second set of parity bits to the memory system;
determine that a third page of the first group of pagelines comprises an uncorrectable error; and
recover second data corresponding to the third page using other pages of the first group of pagelines and the second set of parity bits.

18. The non-transitory computer-readable medium of claim 17, wherein the instructions are further executable by the one or more processors to:
update a data structure of the memory system to indicate that the data was moved from the first page to the second page in response to moving the data from the first page to the second page.

19. The non-transitory computer-readable medium of claim 17, wherein the instructions to determine the condition associated with the data retention of the first page are executable by the one or more processors to:
determine an occurrence of an uncorrectable error, a read disturbance, a cross-temperature effect, or a combination thereof associated with the data stored to the first page.

20. The non-transitory computer-readable medium of claim 17, wherein the instructions to determine the condition associated with the data retention of the first page are executable by the one or more processors to:
determine that a logical block address associated with the first page is invalid.

21. The non-transitory computer-readable medium of claim 17, wherein the instructions to store the first set of parity bits are executable by the one or more processors to:
store the first set of parity bits to a non-volatile memory in response to closing a virtual block of the non-volatile memory.

22. The non-transitory computer-readable medium of claim 17, wherein the instructions are further executable by the one or more processors to:
store the second set of parity bits to a logical block address of the memory system that is out of range to a host system.

23. The non-transitory computer-readable medium of claim 17, wherein the instructions are further executable by the one or more processors to:
determine that a third page of the first group of pagelines is associated with a weak word line; and
update a data structure of the memory system to indicate that the third page is not used to contribute to the first set of parity bits in response to determining that the third page is associated with a weak word line.

24. The non-transitory computer-readable medium of claim 23, wherein the instructions are further executable by the one or more processors to:
write a generated data pattern to the third page in response to determining that the third page is associated with a weak word line.
